(19) United States
(12) Patent Application Publication
(10) Pub. No.: US 2026/0136198 A1
(43) Pub. Date: May 14, 2026

(54) METHOD FOR SAFELY OPERATING AT LEAST ONE AUTOMATION TECHNOLOGY FIELD DEVICE

(71) Applicant: Endress+Hauser SE+Co. KG, Maulburg (DE)

(72) Inventors: Harald Schäuble, Lörrach (DE); Julian Bockstaller, Schopfheim (DE); Patrick Geib, Bad Säckingen (DE); Tobias Paul, Schopfheim (DE)

(21) Appl. No.: 19/109,661

(22) PCT Filed: Aug. 10, 2023
(86) PCT No.: PCT/EP2023/072194

§ 371 Date: Mar. 7, 2025

(30) Foreign Application Priority Data
Sep. 21, 2022 (DE) 10 2022 124 254.4

(51) Int. Cl. H04W 12/47; H04W 12/50; H04W 12/63

(52) U.S. Cl. CPC H04W 12/47; H04W 12/50; H04W 12/63

(57) ABSTRACT

A method for safely servicing a field device via a mobile end device includes establishing a connection via Bluetooth when a distance between the field device and the end device becomes greater than a first predeterminable distance. and authenticating via the Bluetooth connection using a username and a password. When the distance becomes less than the first predeterminable distance, a connection is established between the field device and the end device via a UWB connection, and an authentication for the field device without input of a username and/or a password via the UWB connection is performed.

The invention relates to a method for safely operating, or servicing, at least one field device of automation technology in an automated plant via a mobile end device.

In process- and manufacturing automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH value, and conductivity. Serving for influencing process variables are actuators, such as, for example, valves or pumps, via which the flow of a liquid in a pipeline section, or the fill level in a container, can be changed. Referred to as field devices are, in principle, all devices, which are applied near to a process and which deliver, or process, process relevant information. Besides the above mentioned sensors and actuators, referred to as field devices are generally also such units, which are connected directly to a fieldbus and serve for communication with superordinated units, thus, for example, remote I/Os, gateways, linking devices and wireless adapters. A large number of such field devices are manufactured and sold by the Endress+Hauser group of companies.

In order to enable wireless data transmission between such a field device and a mobile end device, present field devices have diverse radio interfaces, such as, for example, WLAN, Bluetooth, and/or near field communication (NFC). By means of these interfaces, a connection to a corresponding field device can be produced, in order to enable accessing its measured-, or actuating, values and/or data, e.g. parameters. Typically used for the data transmission are mobile end devices, which are likewise equipped with diverse radio interfaces. Such mobile end devices can be, for example, smartphones, tablet computers, or notebook computers.

For reasons of safety, it is currently usual that an operator desiring to service, e.g. configure and/or parameter, a field device by means of a mobile end device, must first authenticate via a password. In contrast therewith, an operator at the site of the field device, at least for accessing parts of the data and/or measured-, or actuating, values, does not need to perform any authentication. This is because it is assumed that an operator, who has access to the plant, is also authorized to access data and/or measured-, or actuating, values of the field device.

Since not all field devices located in a plant are easily accessible, a reasonable option, in such case, is to perform servicing with the aid of a mobile end device. In such case, the operator has, however, to authenticate with a username and/or a password at each individual field device to be serviced, before being able to access data and/or measured-, or actuating, values of the device.

An object of the invention is to improve this situation.

The object is achieved according to the invention by the method as defined in claim 1.

The method of the invention for safely operating, or servicing, at least one field device of automation technology in an automated plant via a mobile end device provides that, when a first distance between the field device and the mobile end device ascertained by means of a UWB connection is or becomes greater than or equal to a first predeterminable distance, a connection establishment between the field device and the mobile end device by means of a Bluetooth connection and an authentication for the field device via the Bluetooth connection by means of input of a username and/or a password are performed with the mobile end device by an operator, such that, in case of successful authentication, the operator can access at least a part of the data and/or measured-, or actuating, values of the field device via the Bluetooth connection, and, when the first distance between the field device and the mobile end device ascertained by means of the UWB connection is or becomes less than the first predeterminable distance, a connection establishment between the field device and the mobile end device by means of the UWB connection and/or the Bluetooth connection is performed in such a manner that an authentication for the field device occurs via the UWB connection without input of a username and/or a password, such that, in case of successful authentication, the operator can access at least a part of the data and/or measured-, or actuating, values of the field device via the UWB connection or the Bluetooth connection.

According to the invention, a method is provided, in the case of which an operator can service a field device by means of a mobile end device, without it being necessary to authenticate via input of a username and/or password, as soon as the operator is located within a predeterminable distance from the field device. The distance is ascertained, in such case, according to the invention, by means of a UWB connection and, thus, via the Time-of-Flight (ToF) method. As soon as the distance is within a first predeterminable distance, an authentication for the field device can occur via the UWB connection without input of a username and/or a password. As a result, the servicing of the field device by the operator is as if the operator is directly at the field device and servicing it directly via the integrated display.

An advantageous form of embodiment of the method of the invention provides that access rights for the data and/or measured-, or actuating, values are controlled as a function of additional predeterminable distances between the field device and the mobile end device less than the first distance.

An advantageous form of embodiment of the method of the invention provides that, when, after successful authentication via the UWB connection, the first distance between the field device and the mobile end device is or becomes greater than the first predeterminable distance, the accessing of data and/or measured-, or actuating, values of the field device through the mobile end device is disabled.

An alternative form of embodiment of the method of the invention provides that, when, after successful authentication via the UWB connection, the first distance between the field device and the mobile end device is or becomes greater than the first predeterminable distance, the accessing of data and/or measured-, or actuating, values of the field device by the mobile end device is maintained, until the Bluetooth connection and/or UWB connection is interrupted.

An advantageous form of embodiment of the method of the invention provides that the first predeterminable distance and/or the additional predeterminable distances are predeterminable by an operator of the automated plant.

An advantageous form of embodiment of the method of the invention provides that the mobile end device shows the operator all field devices located within the first distance from the mobile end device.

An advantageous form of embodiment of the method of the invention provides that the mobile end device also shows distance to each field device.

An advantageous form of embodiment of the method of the invention provides that, upon a successful authentication for a field device via the UWB connection, a navigation to the field device is enabled in the mobile end device.

The invention will now be explained in greater detail based on the appended drawing. The sole FIGURE of the drawing shows as follows:

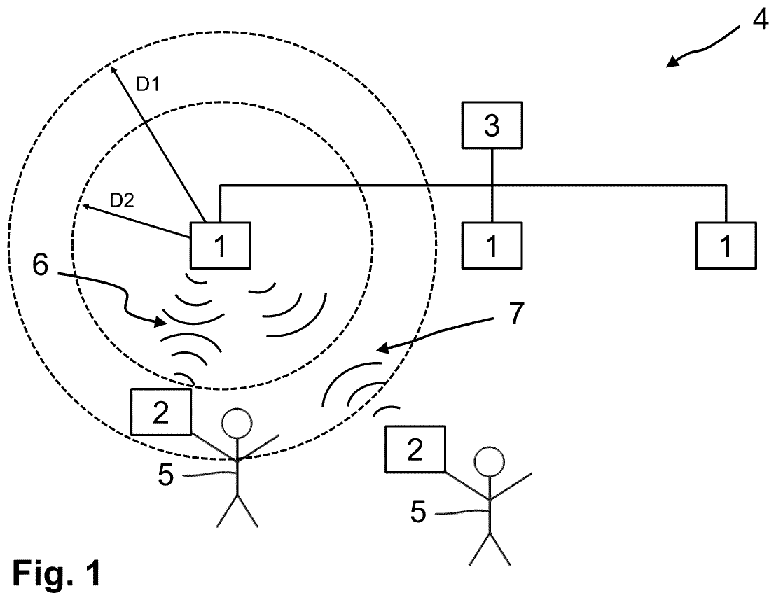

FIG. 1: schematically, an automated plant with, by way of example, three field devices of automation technology, in order to illustrate the method of the invention.

FIG. 1 shows, schematically, basic features of an automated plant 4 having, by way of example, three field devices 1, which can be connected to a superordinated unit 3 for data transmission.

In order to enable a wireless data transmission between such a field device 1 and a mobile end device 2, each, that is, the field device 1 and the mobile end device 2, has a Bluetooth interface and a UWB interface for wireless data transmission. The mobile end device 2 can, in such case, such as above mentioned, be a smart phone, a tablet computer, or a notebook computer. Additionally used as mobile end devices can also be the mobile service or operating devices specially made for servicing field devices.

The method of the invention provides that a connection establishment between a field device 1 and the mobile end device 2 by means of a Bluetooth connection 7 occurs, when a first distance D1 between the field device 1 and the mobile end device 2 is or becomes greater than or equal to a first predeterminable distance. The first distance is ascertained, in such case, via a UWB connection 6 and, thus, via the Time-of-Flight (ToF) method. The first predeterminable distance can be determined, or predetermined, for example, by the operator of the automated plant. An example of a first distance D1 can range up to about 7 m, preferably up to about 6 m, especially preferably up to about 5 m.

Using the mobile end device 2, the operator 5 can initiate the actual connecting in the automated plant 4 when located within radio range of the field device 1 but not directly at the site of the field device 1. For this, the operator 5 can be shown, for example, all field devices within radio range. Such can occur e.g. in the form of a list, such that the operator 5 can select, with which field device 1 a connection should be established. In supplementation, the operator 5 can also be given information concerning distance of a field device 1 from the mobile end device 2, e.g. the distance is shown on the display of the mobile end device. Of course, the connection cannot be made when the field 25 device 1 is farther from the mobile end device 2 than the range for a Bluetooth connection.

Following establishing of the Bluetooth connection, the method provides for an authentication for the field device where the operator inputs into the mobile end device a username and/or password, such that in case of successful authentication the operator can access data and/or measured-, or actuating, values of the field device via the Bluetooth connection.

The method further provides that, when the first distance between the field device 1 and the mobile end device 2 is or becomes less than a first predeterminable distance D1, a building of a connection between the field device 1 and the mobile end device 2 is performed by means of a UWB connection 6. Then, an authentication for the field device 1 is executed via the UWB connection 6 without input of a username and/or a password, such that in case of a successful authentication the operator 5 can access data and/or measured-, or actuating, values of the field device 1 via the UWB connection 6 or the Bluetooth connection 7. In a preferred variant of the method, after successful authentication via the UWB connection, data and/or measured-, or actuating, values are transmitted only via the Bluetooth connection 7 and not via the UWB connection 6.

In supplementation, the method can provide that, when, after successful authentication via the UWB connection 6, the first distance between the field device 1 and the mobile end device 2 is or becomes greater than the first predeterminable distance D1, the accessing of data and/or measured-, or actuating, values of the field device 1 through the mobile end device 2 is disabled. This means that no more data and/or measured-, or actuating, values can be exchanged. Alternatively, the method can provide that, when, after successful authentication via the UWB connection 6, the first distance between the field device 1 and the mobile end device 2 is or becomes greater than the first predeterminable distance D1, the accessing of data and/or measured-, or actuating, values of the field device by the mobile end device until is maintained, until the Bluetooth connection 7 and/or the UWB connection 6 is interrupted. The interrupting of the Bluetooth connection 7 and/or the UWB connection 6 can be done, in such case, by the operator 5, who initiates the step purposely by corresponding measures at the mobile end device, e.g. breaking the connection. Alternatively, the interrupting of the connection can, however, also occur automatically, e.g. when the mobile end device 2 moves beyond the maximum radio range of the field device 1.

In supplementation, the method can provide that the access rights for the data and/or measured-, or actuating, values are controlled as a function of additional predeterminable distances D2 between the field device 1 and the mobile end device 2, distances which are, in each case, less than first distance. Thus, for example, more access rights can be enabled, as a function of how much closer the mobile end device 2 is to the field device 1. The additional predeterminable distances can likewise be established, e.g. predetermined, by the operator of the automated plant.

The method can further provide that, in case of successful authentication via the UWB connection 6, the operator 5 is given a navigation to the field device 1 in the display of the mobile end device 2.

List of Reference Characters

| | |
|---|---|
| 1 | field device of automation technology |
| 2 | mobile end device |
| 3 | superordinated unit, e.g. PLC |
| 4 | automated plant |
| 5 | operator |
| 6 | UWB connection |
| 7 | Bluetooth connection |
| D1 | first predeterminable distance |
| D2 | an additional predeterminable distance |

1-8. (canceled)

9. A method for safely operating or servicing a field device of automation technology in an automated plant via a mobile end device, the method comprising:
ascertaining via an ultra-wideband (UWB) connection a distance between the field device and the mobile end device;
when the distance between the field device and the mobile end device is or becomes greater than or equal to a first predeterminable distance, establishing a connection between the field device and the mobile end device via a Bluetooth connection and authenticating for the field device via the Bluetooth connection via an input of a username and/or a password with the mobile end device by an operator, such that, in case of successful authentication, the operator can access at least a part of data and/or measured-, or actuating, values of the field device via the Bluetooth connection; and,
when the distance between the field device and the mobile end device ascertained by the UWB connection is or becomes less than the first predeterminable distance, establishing a connection between the field device and the mobile end device via the UWB connection and/or the Bluetooth connection such that an authentication for the field device occurs via the UWB connection without input of a username and/or a password, such that, in case of successful authentication, the operator can access at least a part of the data and/or measured-, or actuating, values of the field device via the UWB connection or the Bluetooth connection.

10. The method as claimed in claim 9, wherein access rights for the data and/or measured-, or actuating, values are controlled as a function of an additional predeterminable distance between the field device and the mobile end device that is less than the first predeterminable distance.

11. The method as claimed in claim 9, further comprising:
when, after successful authentication via the UWB connection, the distance between the field device and the mobile end device is or becomes greater than the first predeterminable distance, disabling the accessing of data and/or measured-, or actuating, values of the field device by the mobile end device.

12. The method as claimed in claim 11, wherein, when after successful authentication via the UWB connection, the distance between the field device and the mobile end device is or becomes greater than the first predeterminable distance, the accessing of data and/or measured-, or actuating, values of the field device by the mobile end device is maintained until the Bluetooth connection and/or the UWB connection is interrupted.

13. The method as claimed in 9, wherein the first predeterminable and/or the additional predeterminable distance are predeterminable by an operator of the automated plant.

14. The method as claimed in claim 9, further comprising:
showing on the mobile end device all field devices located within the first predeterminable distance from the mobile end device.

15. The method as claimed in claim 14, wherein the mobile end device also shows a distance to each field device.

16. The method as claimed in claim 9, further comprising:
upon a successful authentication for the field device via the UWB connection, enabling a navigation to the field device in the mobile end device.
